(19) United States
(12) Patent Application Publication
(10) Pub. No.: US 2006/0117640 A1
(43) Pub. Date: Jun. 8, 2006

(54) Aquatic life simulation apparatus

(76) Inventor: Robert Castaneda, San Antonio, TX (US)

Correspondence Address: Robert Greeson;7th Floor, 900 Washington Avenue, P.O. Box 1470, Waco, TX, 77603-1470, US

(21) Appl. No.: 10/965,280

(22) Filed: Oct. 14, 2004

(51) Int. Cl. A01K 85/02

(52) U.S. Cl. 43/17.1; 43/17.6; 43/42.31

(57) ABSTRACT

An aquatic life simulation apparatus having a highly detailed and life like finish. The apparatus further contains a waterproof component having a battery and sound chip combination capable of producing various patterns of acoustical signals. The sound chip may be activated upon impact of the apparatus with a body of water and repeat various desired patterns there after. Embodiments of the present apparatus contain LED's in the eye members and along the body of the lure. These embodiments are thought to be particularly useful in simulating live bait sun reflection features.

### BACKGROUND OF THE INVENTION

1. Field of the Invention

The present invention generally relates to an aquatic life simulation apparatus. More specifically, the present invention relates to an aquatic life simulation apparatus that closely replicates the behavior of live bait species and other aquatic species, both with regard to physical appearances and sound patterns. The present invention is particularly useful in that it is capable of producing various life-like acoustical signals to strongly attract surrounding fish.

2. Background Information

Early on, mankind relied on fishing as a means of survival; however, over the years fishing has evolved from solely a means of survival to a sport. And, while the reasons for fishing itself have changed, so have the methods employed. While the first fisherman may have relied on rudimentary spears, nets, or even their bare hands to capture fish—today anglers heavily rely on live bait or artificial lures.

There is a variety of live bait available for use, and even a much wider array of surprisingly sophisticated fishing lures available to bolster the success of any fisherman. These lures come in a surprisingly wide variety of shapes, sizes, and colors. This, in part, is a result of the fact that each size, shape, and color scheme of a particular lure strongly affect the success or failure of a fisherman under particular conditions. For example, a lure having reflective properties may be particularly useful for top water use on a sunny day. That is, as the lure is reeled in it will shimmer in the sun in a manner to attract surrounding fish.

An overwhelming majority of anglers agree in one very important aspect—artificial lures are far superior in catching fish and ease of use when compared to natural bait. It is estimated that out of all the professional or semi professional fish anglers, ninety percent prefer the use of artificial lures over live bait. Such is the result for several reasons. Artificial lures can be easily switched out with one another to maximize productivity according to changing conditions. Also, artificial lures are generally cheaper than live bait. Finally, artificial lures are extremely durable—they can be used over an over again, while live bait obviously has a short operating life.

The development of better lures is further spurred on by the ever-increasing popularity of fishing as a sport. In fact, there is a constantly growing number of publications dedicated to the sport of fishing. Morever, it is not uncommon to come across television programming dedicated solely to fishing. In light of the growing popularity of the sport, and the endless combinations for lure design, a tremendous amount of time and effort is devoted to producing the very best lure. It is not uncommon for a company to spend several thousands of dollars on the research and development of a single artificial lure alone.

Despite the tremendous variety in available lures and their technological advances in recent years, all currently available lures are limited in view of Applicant's invention. That is, while a staggering amount of time and effort has been dedicated to developing the most effective size, shape, and color combination for particular lures, each of these lures lacks an important dimension provided by the present apparatus.

Applicant's invention provides an artificial lure that may be configured to have an effective appearance and produce acoustical signals to entice surrounding fish. Such acoustical signals alert fish to the lure and help the fish determine lure location. Finally, embodiments of the lure are equipped with a programmable microprocessor and are capable of mimicking specific live bait species.

In view of the limitations associated with available lures, mostly their inability to produce acoustical signals and resulting limited ability to attract fish, a great need exists for an artificial lure that offers the same benefits as available lures and additionally attracts fish via acoustical signal patterns. Applicant's invention, as will be fully discussed in the specification to follow, through its numerous embodiments, provides such a lure. More specifically, the present invention provides a lure that is capable of attracting fish through both sight and sound.

Applicant's invention provides an alternative to particular types of bait. One such type of bait the current invention replaces is that of the “croaking” bait, or “croaker” fish. Currently, the only option a fisherman has when using Croaker fish as bait is to purchase actual, live bait. Typically, these types of bait are purchased by a standard size bucket-full at a cost of approximately twenty dollars per bucket. With typical use, a bucket-full of such bait lasts about a half day. As such, a full day of fishing while using this type of bait costs approximately forty dollars for bait alone. On the other hand, the cost associated with the present invention is approximately nine dollars for months or even years of use.

Benefits associated with the present invention include use of a lure that is the product of a sound engineering and manufacturing processes. Also, the current invention is associated with the highest quality units of production, several available feature combinations, and relatively straightforward and efficient manufacturing process. Moreover, the invention has near perfect acoustic rhythm and is capable or reproducing the behavioral characteristics of the specific species of which it is to simulate. Such is the result as the apparatus of the present invention is designed to be extremely precise in duplicating bait species movement and sound as it is being reeled in. Particular versions of the present invention will provide a lure having sound emitting qualities. Other versions will also contain LED's as eye members and LED's along the lure body to simulate the natural sun light reflecting from the scales of a bait species.

Another useful need served by Applicant's invention comes within the realm of aquatic life observation. That is, particular embodiments of the present invention will be equipped with a sound chip (microprocessor) capable of accurately replicating the acoustical patterns of various aquatic species of interest. As such, both the simulated species and surrounding species may be observed in their natural state more easily.

### SUMMARY OF THE INVENTION

It is an object of the present invention to provide an aquatic life simulation apparatus capable of producing various acoustical patterns.

It is another object of the present invention to provide an aquatic life simulation apparatus having a speaker member.

It is another object of the present invention to provide an aquatic life simulation apparatus that closely replicates the behavior of any number of predetermined aquatic species.

It is another object of the present invention to provide an aquatic life simulation apparatus that may activate upon impact with a body of water.

It is another object of the present invention to provide an aquatic life simulation apparatus that is extremely durable.

It is another object of the present invention to provide an aquatic life simulation apparatus that is cost effective.

It is another object of the present invention to provide an aquatic life simulation apparatus that emits light from its body.

It is another object of the present invention to provide an aquatic life simulation apparatus that emits light from its eyes.

In view of the foregoing and other related objectives, Applicant's invention provides a highly innovative aquatic life simulation apparatus. Most embodiments generally have a very soft and durable exterior body and are air brushed to the likeness of a particular species. That is, the air brush finish adds detail to the apparatus so that the it can take on several appearances—any of which can be selected according to conditions and desires.

Perhaps the most novel feature of the claimed invention is its inner capsule and combination of components contained therein. In most preferred forms, the inner capsule is waterproof and contains a “sound chip,” capable of producing acoustical patterns very closely resembling those of any number of aquatic species. The desired result may be to entice surrounding fish or simply to replicate a particular species within its natural environment. In the preferred form, this sound chip is operationally coupled with a power source and a speaker member. Remarkably, this sound chip is embedded with acoustical information associated with any number of specific aquatic species.

Further, the sound chip may be programmed to begin its acoustical pattern as soon as the apparatus makes contact with the water. This is accomplished as the sound chip may be further coupled to a motion sensing means and configured to activate upon impact.

As mentioned, the sound chip may receive and perform several distinct acoustical patterns, and in one preferred form, the apparatus of the present invention will be able to accurately reproduce the sounds and movements associated with creatures eaten by game fish. For example, a particularly effective embodiment of the present invention is capable of performing the sound and pattern of “croaking” associated with species commonly preyed upon by game fish. By way of further example, the sound chip may repeat a pattern where it emits acoustical signals for a period of ten seconds and then remain dormant for ten seconds. Such a pattern may be preferred in that it allows for the “jerk and reel” procedure commonly preferred by fisherman.

Certain embodiments of the present invention include other novel features such as realistic appearing eyes and body members. That is, these embodiments include LED's throughout the apparatus eye figures and along the body. Such characteristic is particularly useful in replicating the effect of the sun reflecting from aquatic life.

### BRIEF DESCRIPTION OF THE DRAWINGS

FIG. 1 is a side view of the apparatus of the present invention.

### DETAILED DESCRIPTION OF THE PREFERRED EMBODIMENT

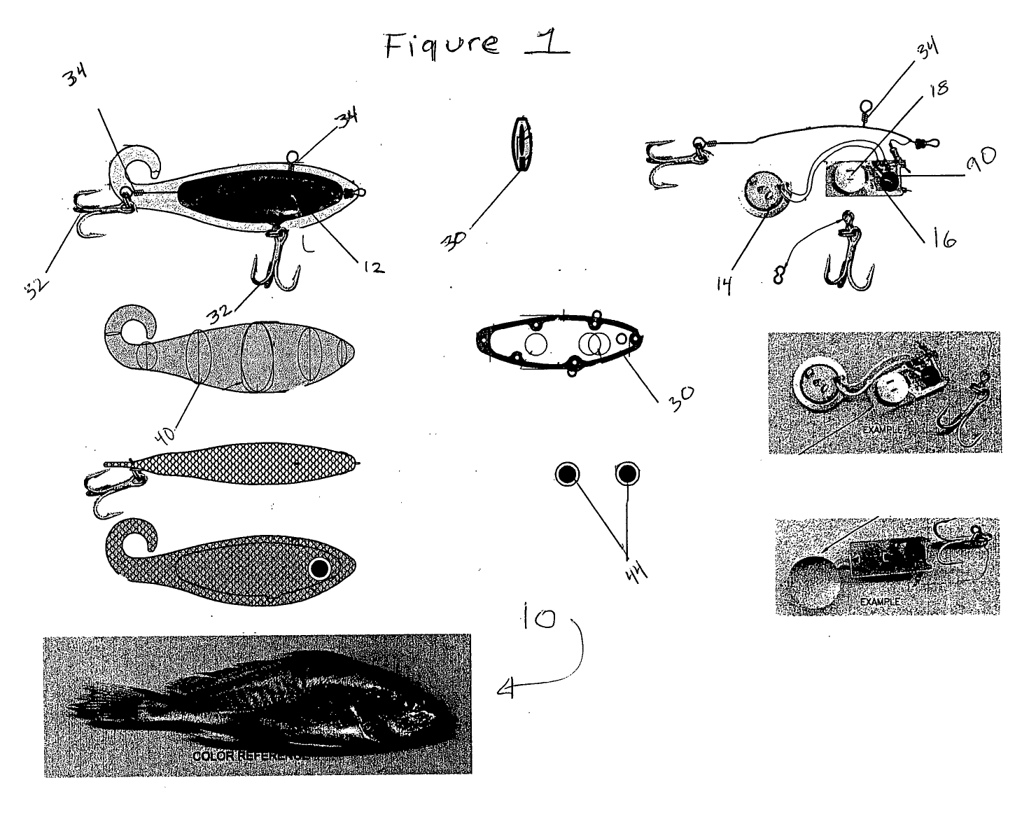

Referring to FIG. 1, the aquatic life simulation apparatus of the present invention is generally designated by numeral 10. Apparatus 10, in the preferred embodiment, is one of three primary colors: copper, bronze, or chrome. In addition, apparatus 10 may be finished with some material to further enhance the reflective value of apparatus 10. While the preferred embodiment is thought to be most beneficial when having a metallic-type finish as mentioned above, other useful embodiments are envisioned where apparatus 10 may be of other bright color scheme. For instance, a neon color combination scheme is thought to be particularly useful for attracting fish under certain conditions.

Apparatus 10 is characterized by inner capsule 12. In the preferred embodiment, inner capsule 12 houses and protects speaker member 14, microprocessor 16, battery member 18, and motion sensing means 90. Inner capsule 12 holds speaker 14, microprocessor 16, battery 18, and motion sensing means 90 in a water-free environment, and further acts as an impact absorbing means for these components. As such, the components contained within capsule 12 are protected from both water and incident forces by virtue of being contained within capsule 12.

In the preferred embodiment, inner capsule 12 may be primarily composed of rubber, plastic, fiberglass, or some combination thereof. Other embodiments are particularly useful where speaker 14 is not housed within capsule 12, but is adjacent to capsule 12 and remains in combination with the other referenced components contained with capsule 12. In such embodiments, speaker 14 is a water resistant or waterproof speaker appropriately sized to fit within apparatus 10. Such speaker members are known, and will be apparent to those skilled in the art.

As mentioned, operation of apparatus 10 involves the components housed within capsule 12. Upon some trigger event, such as impact with water or relative motion of apparatus 10, microprocessor 16 performs according to its stored programming. That is, embodiments are envisioned where microprocessor 16 is operationally coupled with motion sensing means 90. In such embodiments, sensing means 90 reacts to changes in velocity of apparatus 10. Upon sufficient reaction, sensing means 90 signals microprocessor 16 to initiate performance. Microprocessor 16 then acts according to the reaction of sensing means 90. This action may be carried out for a determined time and then cease, or continue in repeated fashion. Finally, one of the most novel aspects of the present invention if the ability of microprocessor 16 to accurately and precisely replicate the acoustical patterns of a variety of aquatic life. This replication is carried out according to stored programming of microprocessor 16.

Microprocessor 16 is further operationally coupled with, and powered by, battery 18. In the preferred embodiment, battery 18 is a relatively small, low voltage battery. Such is preferred as the target weight of apparatus 10 is less than one half ounce.

Microprocessor 16 is electronically coupled with speaker member 14, where speaker 14 emits acoustical patterns according to signals received from microprocessor 16. In the preferred embodiment, speaker 14 is of a “micro speaker” variety as known to those skilled in the art, typically having a diameter of less than one inch.

Finally, other useful embodiments are envisioned where some light emitting means, such as a series of LED's, is further in combination with microprocessor 16. In such embodiments, these LED's are activated upon signals received from microprocessor 16. The most beneficial arrangement of such light emitting means is envisioned where LED's are dispersed along the peripheral body of apparatus 10 and/or placed as eye members. Such arrangement is thought to be most beneficial in simulating real-life behavioral characteristics.

Apparatus 10 is further characterized by support member 30. In the preferred embodiment, support member 30 aligns with capsule 12 and is configured to ensure apparatus 10 remains engaged with a fishing line. Support member 30 imparts rigidity and strength to apparatus 10 and may be configured to directly receive and mate with a hook member 32.

Support member 30 may also receive a hook member connection means 34. Hook connection means 34 may be a fishing line of sufficient strength to withstand the force exerted by an expected fish snared by hook 32. In each of these embodiments, support member 30, in combination with hook member 32, or in combination with both hook member 32 and hook connection means 34, provide a mechanism whereby a fish may take apparatus 10 within its mouth and then become snagged by hook member 32. As the fish attempts to retreat, support member 30, hook 32, and possibly connection means 34, hold the fish engaged with apparatus 10 while apparatus 10 remains secured to a fishing line. Finally, other useful embodiments are envisioned where capsule 12 is further configured to replace support member 30. That is, by ensuring capsule 12 is of sufficient strength, capsule 12 may directly receive and mate with hook member 12 or hook connection means 34.

Apparatus 10 further has an outer member 40. Outer member 40 surrounds and substantially covers capsule 12 and support 30. Also, member 40 primarily provides apparatus 10 with its actual, final physical appearance. As such, in it most preferred form, member 40 is comprised mostly of plastic or rubber, or some composite thereof and finished with metallic-type appearing finish. Such a finish, is particularly useful as it reflects sunlight to further attract predator attention. As mentioned, particularly useful embodiments are envisioned where member 40 contains LED's or some other light-emitting means (such as micro-bulbs or fiber optics members) along its length and along eye members 44. Such embodiments, through their light-emitting quality, and in combination with acoustical signals sent from apparatus 10, further attract the attention of surrounding fish.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An apparatus for simulating aquatic life, comprising:
a microprocessor having sufficient memory and capability to perform aquatic life simulation operations, where said microprocessor is operationally coupled with a power source, and where said microprocessor is operationally coupled with a speaker member;
said speaker member being configured to emit acoustical patterns according to information received from said microprocessor, and where said speaker member is relatively small, preferably having a diameter of one inch or less;
said power source being of relatively low voltage;
a first capsule substantially enclosing said microprocessor, said power source, and said speaker member in a substantially water free environment, and where said first capsule is configured to receive either a hook member or a hook connection means, and where said first capsule is of sufficient strength and rigidity to maintain structural integrity of said apparatus while said apparatus is engaged with a fish;
a second capsule substantially enclosing said first capsule and having a form closely resembling an aquatic life species.

2. An apparatus for simulating aquatic life, comprising:
a microprocessor having sufficient memory and capability to perform aquatic life simulation operations, where said microprocessor is operationally coupled with a power source, and where said microprocessor is operationally coupled with a speaker member;
said speaker member being configured to emit acoustical patterns according to information received from said microprocessor, and where said speaker member is relatively small, preferably having a diameter of one inch or less;
said power source being of relatively low voltage;
a first capsule substantially enclosing said microprocessor, said power source, and said speaker member in a substantially water free environment;
a support member aligned with said first capsule, where said first capsule is configured to receive either a hook member or a hook connection means, and where said first capsule is of sufficient strength and rigidity to maintain structural integrity of said apparatus while said apparatus is engaged with a fish;
a second capsule substantially enclosing said first capsule and said support member and having a form closely resembling an aquatic life species.

3. The apparatus of claim 1, wherein
said second capsule comprises one or more eye members where each eye member contains a light emitting means.

4. The apparatus of claim 1, wherein
said second capsule comprises one or more light emitting means spaced along said second capsule.

5. The apparatus of claim 1, wherein
said second capsule is finished with a metallic-type finish.

6. The apparatus of claim 2, wherein
said second capsule comprises one or more eye members where each eye member contains a light emitting means.

7. The apparatus of claim 2, wherein
said second capsule comprises one or more light emitting means spaced along said second capsule.

8. The apparatus of claim 2, wherein
said second capsule is finished with a metallic-type finish.

9. The apparatus of claim 3, wherein
said second capsule comprises one or more light emitting means spaced along said second capsule.

10. The apparatus of claim 3, wherein
said second capsule is finished with a metallic-type finish.

11. The apparatus of claim 4, wherein
said second capsule is finished with a metallic-type finish.

12. The apparatus of claim 6, wherein
said second capsule comprises one or more light emitting means spaced along said second capsule.

13. The apparatus of claim 6, wherein
said second capsule is finished with a metallic-type finish.

14. The apparatus of claim 7, wherein
said second capsule is finished with a metallic-type finish.

15. The apparatus of claim 1, further comprising
a motion sensing means operationally coupled with said microprocessor where said motion sensing means reacts to velocity changes of said apparatus and communicates with said microprocessor according to such reaction.

16. The apparatus of claim 2, further comprising
a motion sensing means operationally coupled with said microprocessor where said motion sensing means reacts to velocity changes of said apparatus and communicates with said microprocessor according to such reaction.
